(19) United States
(12) Patent Application Publication
(10) Pub. No.: US 2007/0198541 A1
(43) Pub. Date: Aug. 23, 2007

(54) Method and system for efficiently storing semantic web statements in a relational database

(75) Inventors: Joseph P. Betz, Arlington, MA (US); Christopher R. Vincent, Arlington, MA (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/348,196

(22) Filed: Feb. 6, 2006

(51) Int. Cl. G06F 7/00

(52) U.S. Cl. 707/100

(57) ABSTRACT

Disclosed are a method and system for storing semantic web statements in a relational database. The method comprises the steps of providing a repository for said semantic web statements, and providing a relational database including one or more specific tables. Each of these specific tables includes (i) one column holding a Uniform Resource identifier (URI) key, and (ii) one or more additional columns holding components of said semantic web statements. A specific table component registry is established to connect the specific tables to said repository, and this registry includes an entry for each of said specific tables for converting data in said tables to one of said semantic statements.

### BACKGROUND OF THE INVENTION

1. Field of the Invention

This invention generally relates to semantic web technology, and more specifically, to methods and systems for efficiently storing semantic web statements in a relational database. Even more specifically, the invention relates to such methods and systems that are particularly well suited for use with the Resource Description Framework (RDF) language.

2. Background Art

RDF is a language used to represent information, particularly meta data, about resources available in the World Wide Web. For example, RDF may be used to represent copyright or licensing information about a document on the Web, or the author and title of a particular Web page. RDF can also be employed for representing data or meta data about items or matters that can be identified on the World Wide Web even though these items cannot be directly retrieved from the Web. Examples of these latter items may include data about a user's Web preferences, and information, such as the price and availability, of items for sale at on-line shopping facilities. Specifications for RDF are established by the World Wide Web Consortium.

RDF uses identifiers, referred to as Uniform Resource Identifiers, or URIs, and is based on a specific terminology. An RDF statement includes a subject, a predicate and an object. The subject identifies the thing, such as person or Web page, that the statement is about. The predicate identifies the property or characteristic, such as title or owner, of the subject of the RDF statement, and the object identifies a value of that property or characteristic. For example, if the RDF statement is about pet owners, the subject might be “owner,” the predicate could be “name,” and the object could be “Joe.” This format, among other advantages, allows RDF to represent statements as a graph of nodes and arcs. In the graph, the subjects and objects may be represented by, for example, ovals, circles or squares, or some combination thereof, while the predicates of the RFD statements may be represented by arcs or arrows connecting the subject of each statement with the object of the statement.

An important feature of RDF is that it provides a common framework for expressing information. This allows this information to be exchanged among applications without losing any meaning of the information. Because of this common framework, application developers can utilize the availability of common tools and parsers to process RDF information.

RDF data access requests in conventional systems are defined by “Triple Patterns,” which limit the RDF statement(s) they are requesting by constraining any or all of the three parts of an RDF statement: the subject, predicate and object. For example, the triple pattern “(<Person001>, <name>, ?)” requests only RDF statements where the subject is “Person001,” and the predicate is “name” (the “?” for the object is used as a wildcard and means the object can be anything).

A number of RDF storage systems are built on top of relational databases. In such systems, RFD statements are stored in relational database tables created specifically to hold RDF. Such systems cannot be used to store RDF in tables other than the ones specifically designed for these systems to store RDF. Additionally, such systems do not optimize storage for commonly occurring RDF structures.

### SUMMARY OF THE INVENTION

An object of this invention is to store efficiently semantic web statements in a relational database.

Another object of the present invention is to store semantic web statements in relational tables designed specifically for such structures.

A further object of the invention is to extend read access of RDF data to non-RDF enabled systems or system components

These and other objectives are attained with a method and system for storing semantic web statements in a relational database. The method comprises the steps of providing a repository for said semantic web statements, and providing a relational database including one or more specific tables. Each of these specific tables includes (i) one column holding a Uniform Resource identifier (URI) key, and (ii) one or more additional columns holding components of said semantic web statements. A specific table component registry is established to connect the specific tables to said repository, and this registry includes an entry for each of said specific tables for converting data in said tables to one of said semantic statements.

Preferably, each of the specific tables includes one or more rows, and each row of the specific tables represents a set of semantic web statements. Also, in a preferred embodiment, the semantic web statements include subjects and objects; and for each row of the specific tables, (i) one or more entries in the row combine to make the subject of one of said semantic web statements, and (ii) the remaining entries in the row are, or combine to be, the object of that one of said semantic web statements. Any suitable procedure may be used to access the semantic web statements. For example, access procedures are described in This system not only allows a system to express access control rules but also enforces them by storing access control data in specific tables, for example as described in copending application no. (Attorney Docket POU920050098US1) for “Method and System For Controlling Access To Semantic Web Statements,” the disclosure of which is hereby incorporated herein by reference.

Also disclosed herein is a hybrid system that uses the above described method to more efficiently store RDF in these specific tables where it can, and uses conventional RDF storage tables for statements that have no place in the specific tables. In addition, such a system may extend read access of the RDF data to non-RDF enabled systems or system components

Further benefits and advantages of the invention will become apparent from a consideration of the following detailed description, given with reference to the accompanying drawings, which specify and show preferred embodiments of the invention.

### DESCRIPTION OF THE DRAWINGS

FIG. 1 depicts how many conventional RDF storage systems store the subject, predicate and object components of each RDF statement into a single Statement table.

FIG. 2 illustrates how, in a system embodying the present invention, RFD data can be stored into existing database tables that are in use by other parts of the system.

FIG. 3 shows an RDF statement in graph form and how that statement can be stored partially in a new table and partially in a conventional Statement table.

FIG. 4 depicts how the RDF graph of FIG. 3 may be stored exclusively in two new tables, and the conventional Statement table remains empty.

FIG. 5 exemplifies how RDF anonymous nodes may be stored using the present invention. Like FIG. 3, the Statement table of FIG. 5 remains empty.

FIG. 6 is a flow diagram describing how a data access of RDF in this invention uses Triple Patterns to intercept data access requests.

FIG. 7 shows the data in a Specific Table Component registry used in the preferred embodiment of this invention.

FIG. 8 shows example requests made to the registry by the RDF Storage System for a RDF triple pattern match.

### DETAILED DESCRIPTION OF THE PREFERRED EMBODIMENTS

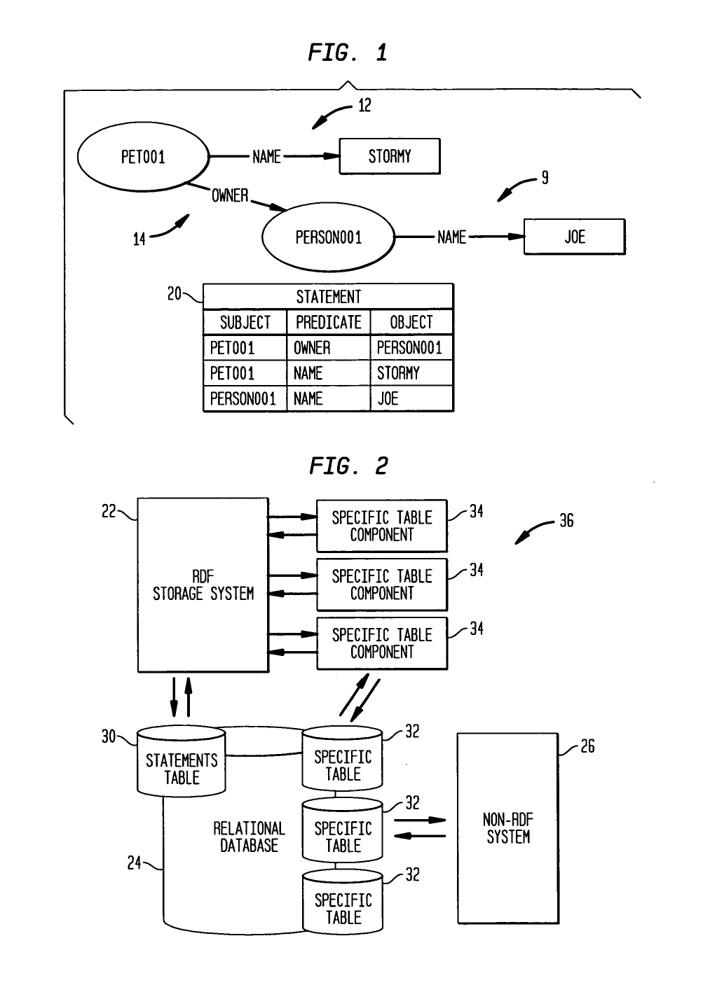

FIG. 1 depicts how RDF statements may be stored in a conventional RDF repository. Three RDF statements, referenced at 12, 14 and 16, are shown in FIG. 1, and these statements are stored in a Statement Table 20 in a relational database with columns for the “subject,” “predicate” and “object” of the RDF statements. In one statement 12, the subject is Pet001, the predicate is owner, and the object is Person001. In a second statement 14, the subject is, again, Pet001, the predicate is name, and the object is Stormy. In the third shown statement 16, the subject, predicate, and object are, respectively, Person001, name and Joe.

This conventional RDF repository can be extended to implement the present invention. FIG. 2 depicts a conventional RDF storage system 22, a relational database 24, and non-RDF system components 26. FIG. 2 also shows a conventional Statements table, a set of specific tables 32, and a set of specific table components 34.

Thus, as can be seen, for the present invention, additional tables 32 are added to the relational database 24. Each of these additional tables has at least one “URI key” (a column or set of columns that holds or can be converted to a URI), and any number of additional columns, each of which stores data of a primitive type such as “integer,” “date,” “time,” or “varchar” (text). It may be noted that many relational databases, such as databases of 3rd normal form, designed using conventional practices will meet the requirements of a “Specific Table,” meaning that pre-existing databases and the data they hold can exposed as RDF using the instant invention.

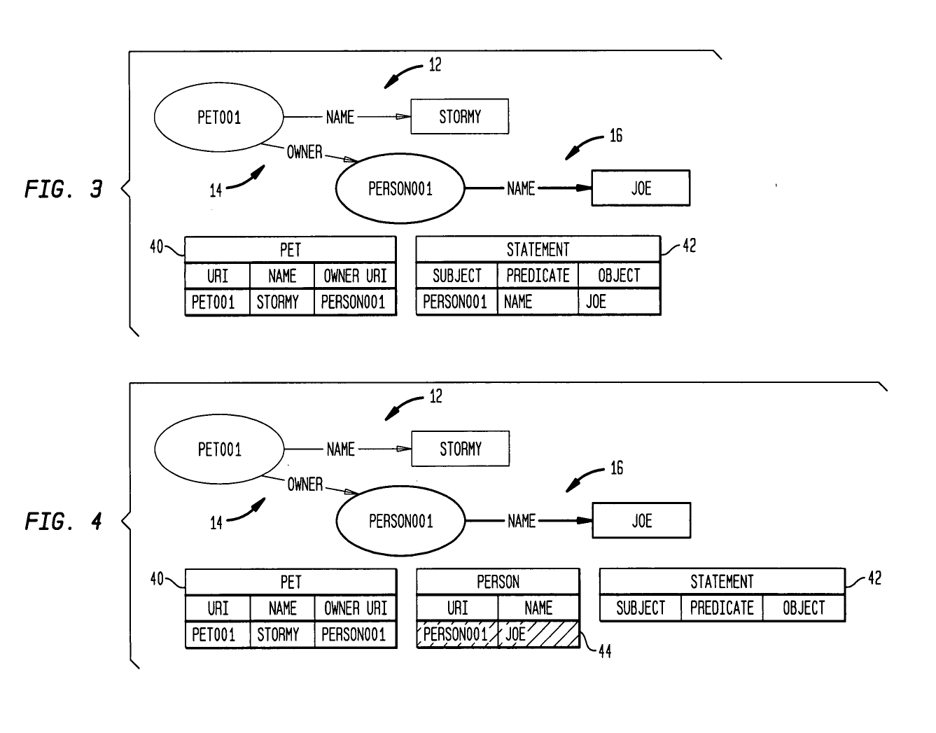

To connect these “specific tables” 22 to a conventional RDF repository 22, a “specific table component” registry 36 is created with an entry for each “specific table” able to convert the data in that “specific table” to RDF statements and to interact with the RDF repository to make these RDF statements available to data access requests. FIG. 3 graphically shows a set of RDF statements 12, 14, 16, and a Specific Table 40 and a conventional Statement Table 42 for holding these statements. With reference to FIGS. 2 and 3, it may be noted that each row in a “Specific Table” represents a set of RDF statements about a subject where one or more of the entries in the row (a “URI key”) combine to make the subject, and the remaining entries either are, or combine to be (again, a “URI key”), an object.

Each “specific table component” keeps track of the “URI key” in the table that stores the subject for each row, a mapping of column to predicate names and a mapping of column names to RDF datatypes for these columns so that the relational database datatypes can be converted to the correct RDF datatype. Once a “specific table component” is created with these properties and mappings, it is able to convert data stored in a relational database into RDF statements. It may also be noted that, with the arrangement shown in FIG. 3, the Statement Table 42 is still needed.

FIG. 4 illustrates how, if another, “Person,” table 44 is added, the RDF graph of FIG. 3 may be stored exclusively in the “Pet” and “Person” tables, and the “Statement” table 42 remains empty.

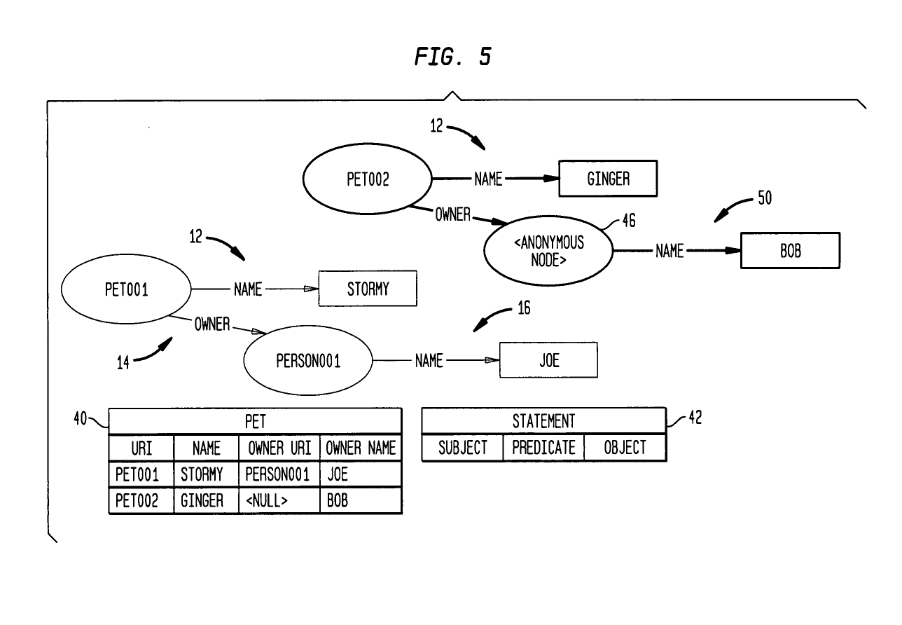

FIG. 5 depicts how an anonymous node 46 may be stored using the present invention. More specifically, FIG. 5 shows a second set of RDF statements, referenced at 50, including an anonymous node 46; and, in this Figure, the “Pet” table 40 is expanded to include owner information. As can be seen, the RDF graph of FIG. 5, including the anonymous node, is stored entirely in the “PET” table. Like FIG. 4, the “Statement” table 42 of FIG. 5 remains empty.

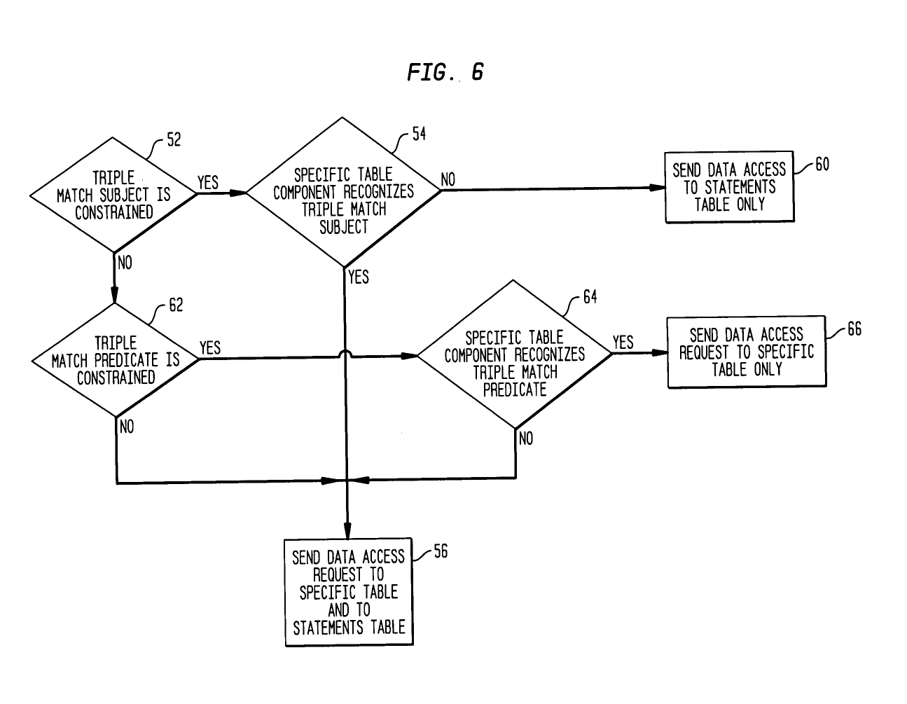

Additionally, with this invention, the conventional RDF repository's data access subsystem may be modified such that read requests for RDF statements destined for the “Statement” table 30 are intercepted by “specific table components” 34 registered with it and are redirected to the appropriate specific table where the data is actually stored. “Specific table components” 34 intercept access requests according to the logic flow shown in FIG. 6. The result is that all the “specific table components” registered with the repository 22 expose the data they store as RDF to data access requests made to the RDF repository.

More particularly, the routine shown in FIG. 6, determines, at step 52, whether a Triple Match subject is constrained. If so, the routine proceeds to step 54, where the routine determines whether a specific table component recognizes that Triple Match subject. If so, the routine proceeds to step 56; and if not, the routine moves on to step 60. At step 56, the data access request is sent to the Statement table only; however, if the routine moves on to step 60, that data access request is sent to both the specific table and to the Statement table.

If, at step 52, the Triple Match subject is not constrained, the routine proceeds to step 62, where the routine determines whether the Triple Match predicate is constrained. If not, the routine proceeds to step 56, where the data access request is sent to both the Specific Table and the Statement table. If at step 62, the Triple Match predicate is constrained, the routine moves on to step 64. At this step, the routine determines whether the Specific table component recognizes the Triple Match predicate. If so, the routine proceeds to step 66; if not, the routine moves on to step 56. At step 66, the data access request is sent to Specific tables only. If however, the routine proceeds to step 56, then the data access request is sent to both Specific table and to Statements table.

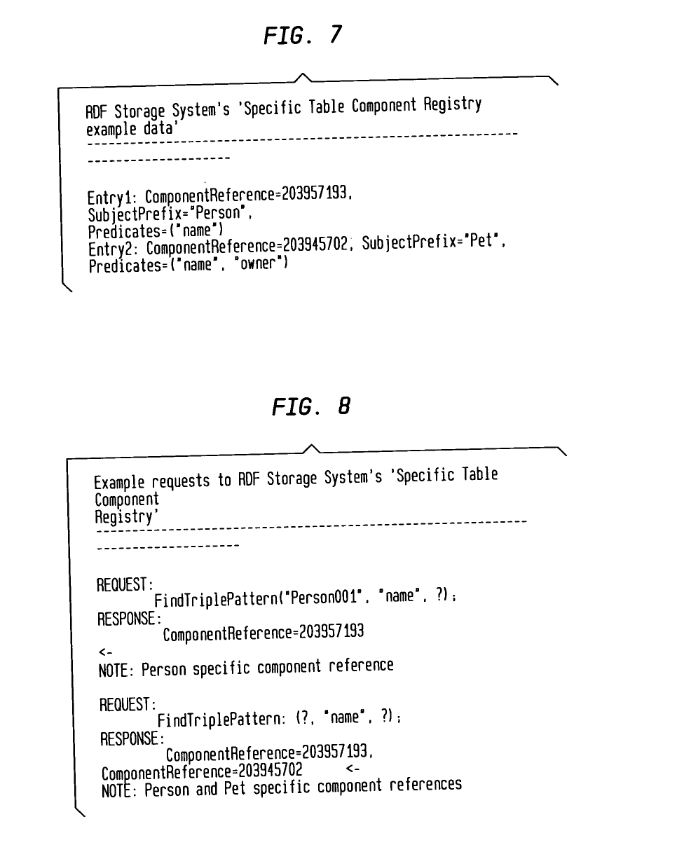

FIG. 7 shows the data in the ‘Specific Table Component registry’ 36 with both the Person and Pet ‘specific table components’ 34 registered. Each registry entry contains a reference (ComponentReference) to a specific table component, an optional prefix (SubjectPrefix) which all statement subjects stored in the specific table component start with (i.e. “Person001” starts with “Person”) and a list of predicates (Predicates) that the specific table component contains statements for. The data for the registry, in our embodiment is stored in a computer file which the registry reads when it is initialized.

FIG. 8 shows example requests made to the registry by the RDF Storage System for a RDF triple pattern match either as part of a query or a statement add. The responses contain references to components that may contain statements for the triple pattern. A triple pattern is for the form “(RDF statement subject, RDF statement predicate, RDF statement object)” where ‘?’ may be used as a wildcard. Requests like these are made from the flow diagram in FIG. 6 steps 54 and 64.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of storing semantic web statements in a relational database, comprising the steps of:
providing a repository for said semantic web statements;
providing a relational database including one or more specific tables, each of said specific tables having (i) one column holding a Uniform Resource identifier (URI) key, and (ii) one or more additional columns holding components of said semantic web statements; and
establishing a specific table component registry to connect the specific tables to said repository, said registry including an entry for each of said specific tables for converting data in said tables to one of said semantic statements.

2. A method according to claim 1, wherein each of said specific tables includes one or more rows, and each row of said specific tables represents a set of semantic web statements.

3. A method according to claim 2, wherein said semantic web statements includes subjects and objects, and for each row of said specific tables, (i) one or more entries in said row combine to make the subject of one of said semantic web statements, and (ii) the remaining entries in said row are, or combine to be, the object of said one of said semantic web statements.

4. A method according to claim 1, wherein each specific table component keeps track of the URI key in one of said specific tables.

5. A method according to claim 1, wherein said repository includes a Statement table capable of holding the semantic web statements, and a data access subsystem for accessing the semantic web statements in the Statement table, and comprising the further steps of:
intercepting access requests for semantic web statements in the Statement table; and
redirecting said access requests to said specific tables.

6. A method according to claim 5, wherein said access requests are intercepted by and redirected by said specific table components.

7. A system for storing semantic web statements in a relational database, comprising:
a repository for said semantic web statements;
a relational database including one or more specific tables, each of said specific tables having (i) one column holding a Uniform Resource identifier (URI) key, and (ii) one or more additional columns holding components of said semantic web statements; and
a specific table component registry to connect the specific tables to said repository, said registry including an entry for each of said specific tables for converting data in said tables to one of said semantic statements.

8. A system according to claim 7, wherein each of said specific tables includes one or more rows, and each row of said specific tables represents a set of semantic web statements.

9. A system according to claim 8, wherein said semantic web statements includes subjects and objects, and for each row of said specific tables, (i) one or more entries in said row combine to make the subject of one of said semantic web statements, and (ii) the remaining entries in said row are, or combine to be, the object of said one of said semantic web statements.

10. A system according to claim 7, wherein each specific table component keeps track of the URI key in one of said specific tables.

11. A system according to claim 7, wherein said repository includes a Statement table capable of holding the semantic web statements, and a data access subsystem for accessing the semantic web statements in the Statement table, and wherein said data access subsystem intercepts access requests for semantic web statements in the Statement table, and redirects said access requests to said specific tables.

12. A system according to claim 11, wherein said access requests are intercepted by and redirected by said specific table components.

13. A program storage device readable by machine, tangibly embodying a program of instructions executable by the machine to perform method steps for storing semantic web statements in a relational database, said method steps comprising:
providing a repository for said semantic web statements;
providing a relational database including one or more specific tables, each of said specific tables having (i) one column holding a Uniform Resource identifier (URI) key, and (ii) one or more additional columns holding components of said semantic web statements; and
establishing a specific table component registry to connect the specific tables to said repository, said registry including an entry for each of said specific tables for converting data in said tables to one of said semantic statements.

14. A program storage device according to claim 13, wherein each of said specific tables includes one or more rows, and each row of said specific tables represents a set of semantic web statements.

15. A program storage device according to claim 13, wherein said semantic web statements includes subjects and objects, and for each row of said specific tables, (i) one or more entries in said row combine to make the subject of one of said semantic web statements, and (ii) the remaining entries in said row are, or combine to be, the object of said one of said semantic web statements.

16. A program storage device according to claim 13, wherein each specific table component keeps track of the URI key in one of said specific tables.

17. A program storage device according to claim 13, wherein said repository includes a Statement table capable of holding the semantic web statements, and a data access subsystem for accessing the semantic web statements in the Statement table, and said method steps further comprise:
intercepting access requests for semantic web statements in the Statement table; and
redirecting said access requests to said specific tables.

18. A program storage device according to claim 17, wherein said access requests are intercepted by and redirected by said specific table components.
